(19) United States
(12) Patent Application Publication
(10) Pub. No.: US 2009/0018907 A1
(43) Pub. Date: Jan. 15, 2009

(54) MANAGING IMPRESSION DEFAULTS

(75) Inventors: Patrick J. McCarthy, Eugene, OR (US); David E. Barousse, JR., Eugene, OR (US); Luke Walsh, Eugene, OR (US); Brad Nelson, Eugene, OR (US); Joseph P. Garstka, Eugene, OR (US); Charles Brian O'Kelley, New York, NY (US)

Correspondence Address: BRINKS HOFER GILSON & LIONE / YAHOO! OVERTURE, P.O. BOX 10395, CHICAGO, IL, 60610, US

(73) Assignee: Right Media, Inc., New York, NY (US)

(21) Appl. No.: 11/776,150

(22) Filed: Jul. 11, 2007

(51) Int. Cl. G06Q 30/00

(52) U.S. Cl. 705/14

(57) ABSTRACT

There are methods and apparatus, including computer program products, for receiving an ad call from a client computing system, determining whether an instance of the ad call was previously-received, and if so, designating a first ad creative supplier associated with the previous instance of the ad call as ineligible to participate in an auction in which a second ad creative supplier is selected to serve an ad creative responsive to the ad call.

### BACKGROUND

This description relates to managing impression defaults.

A conventional approach for publishers to address impression defaults is to run a daisy chain of advertisement networks. Each link of the daisy chain represents an advertisement network. A publisher orders the links in the daisy chain based on the relative cost-per-mille (CPM) deal values associated with the advertisement networks. That is, the first link in the chain represents the advertisement network associated with the highest CPM deal value, the second link in the chain represents the advertisement network associated with the second-highest CPM deal value, and so on. Each subsequent link in the chain is considered the default for the previous link.

In operation, the publisher sends all of its impressions to the advertisement network represented by the first link in the chain and allows that advertisement network to fill as many impressions as it can. When this advertisement network can no longer fill the impressions or chooses to reject certain impressions, it either serves a public service announcement or sends the unwanted impressions on to its “default” network, which is the advertisement network represented by the second link in the chain. This “default” advertisement network is also allowed to fill as many impressions as it can prior to defaulting the impressions to its own “default” advertisement network, which is represented by the third link in the chain. This “fill and default” process is repeated through the links in the daisy chain. Although the last link in the chain typically represents an advertisement network with a 100% fill rate, inefficiencies arise in those instances in which the fill rate is less than 100% and impressions remain unsold after the daisy chain is exhausted.

### SUMMARY

In one aspect, the invention features a computer-implemented method that includes receiving an ad call at an exchange computing system from a client computing system; and determining whether an instance of the ad call was previously-received, and if so, designating a first ad creative supplier associated with the previous instance of the ad call as ineligible to participate in an auction in which a second ad creative supplier is selected to serve an ad creative responsive to the ad call.

Implementations of the invention may include one or more of the following.

The first ad creative supplier is a first advertiser or ad network; and the second ad creative supplier is a second advertiser or ad network.

The method may further include performing the auction at the exchange computing system, and sending an ad tag associated with the second ad creative supplier to the client computing system.

The method may further include performing the auction at the exchange computing system by comparing bids associated with a set of ad creative suppliers, and identifying the second ad creative supplier from amongst the set of ad creative suppliers as being associated with a winning bid for the auction. The winning bid may correspond to a bid price that yields a highest revenue for a publisher. The method of determining whether an instance of the ad call was previously-received may include determining whether the ad call includes information representative of an ad creative supplier that defaulted on serving an ad creative responsive to the previous instance of the ad call. The method may further include counting, at the exchange computing system, a defaulted impression towards the first ad creative supplier upon the designating.

In another aspect, the invention features a computer-implemented method that includes determining whether an ad call received from a client computing system results from an execution of a set of instructions included in a passback tag, and if so, designating each ad creative supplier having an identifier present in the received ad call as ineligible to participate in an auction in which an ad creative supplier is selected to serve an ad creative responsive to the ad call.

Implementations of the invention may include one or more of the following.

The method of determining whether an ad call received from the client computing system results from an execution of a set of instructions included in a passback tag includes examining the ad call to determine whether the ad call includes information representative of an ad creative supplier that defaulted on serving an ad creative responsive to a previous instance of the ad call. The method further includes sending an ad tag associated with the selected ad creative supplier to the client computing system. The method further includes performing the auction by comparing bids associated with a set of ad creative suppliers, and identifying, from amongst the set, the ad creative supplier having a bid price that yields a highest revenue for a publisher.

In another aspect, the invention features an online advertisement brokering communication system that includes an exchange computing system. The exchange computing system has a processor and a memory that stores instructions to cause the processor to determine whether an ad call received from the client computing system results from an execution of a set of instructions included in a passback tag, and if so, designate each ad creative supplier having an identifier present in the received ad call as ineligible to participate in an auction in which an ad creative supplier is selected to serve an ad creative responsive to the ad call.

Implementations of the invention may include one or more of the following.

The instructions stored in the memory of the exchange computing system may cause the processor to examine the ad call to determine whether the ad call includes information representative of an ad creative supplier that defaulted on serving an ad creative responsive to a previous instance of the ad call. The memory of the exchange computing system may further store instructions to cause the processor to send an ad tag associated with the selected ad creative supplier to the client computing system. The memory of the exchange computing system may further store instructions to cause the processor to perform the auction by comparing bids associated with a set of ad creative suppliers, and identifying, from amongst the set, the ad creative supplier having a bid price that yields a highest revenue for a publisher.

The online advertisement brokering communication system may also include an ad server having a processor and a memory that stores instructions to cause the processor to selectably default on serving an ad creative responsive to an ad call received from a client computing system; and send a passback tag to the client computing system, the passback tag including a set of instructions operable to cause the client computing system to make an ad call to the exchange computing system. The memory of the ad server may further store one or more passback tags, each passback tag including an ad unit identifier and an ad network identifier. The instructions stored in the memory of the ad server may include instructions to cause the processor to examine the ad call received from the client computing system to identify a requested ad unit; and select the passback tag to be sent to the client computing system based on the requested ad unit, wherein the selected passback tag includes an ad unit identifier corresponding to the requested ad unit.

The online advertisement brokering communication system may also include an ad server having a processor and a memory that stores instructions to cause the processor to selectably default on serving an ad creative responsive to an ad call received from a client computing system; and send a passback URL to the client computing system.

Other general aspects include other combinations of the aspects and features described above and other aspects and features expressed as methods, apparatus, systems, computer program products, and in other ways

The details of one or more examples are set forth in the accompanying drawings and the description below. Further features, aspects, and advantages of the invention will become apparent from the description, the drawings, and the claims.

### DESCRIPTION OF DRAWINGS

FIG. 1 shows an online advertisement brokering communication system.

FIGS. 2 and 3 each show a timing diagram of an exemplary ad creative serving process.

### DETAILED DESCRIPTION

In this description, techniques for enabling a publisher to manage its relationships with advertisement networks are described in the context of a tool (“publisher tool”) that provides the publisher with an interface to an open advertisement exchange. An example of such a publisher tool is the Direct Media Exchange tool provided by Right Media, Inc., New York, N.Y., for use by publishers in managing advertisement network relationships on the Right Media Exchange. The publisher tool enables the publisher to implement a “passback” mechanism that eliminates the inefficiencies that arise from the use of daisy chains in capturing defaulted impressions. This “passback” mechanism enables advertisement networks, within and outside of the exchange, to compete on a level playing field for each impression. This ensures that the publisher's revenue is maximized while avoiding the problem of unsold impressions.

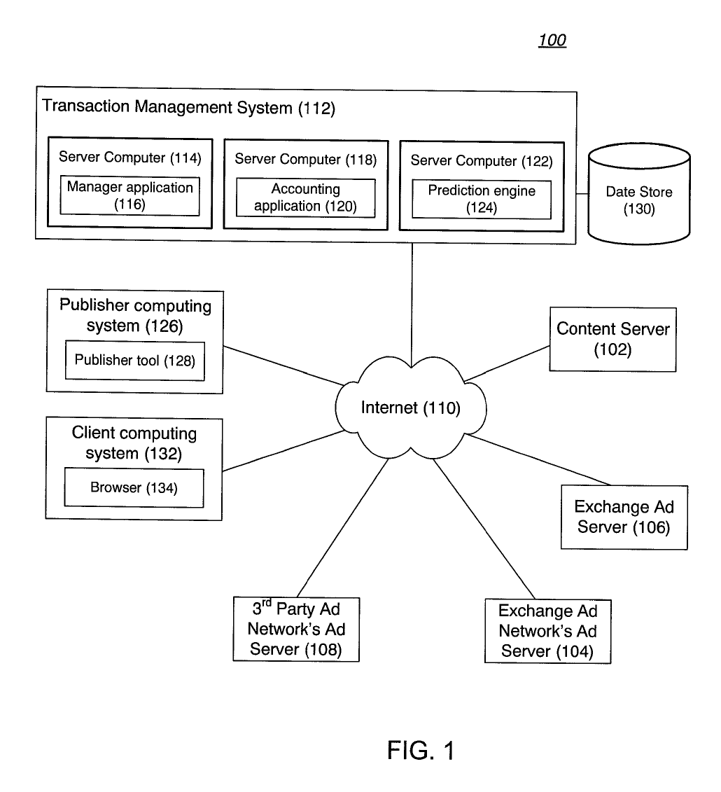

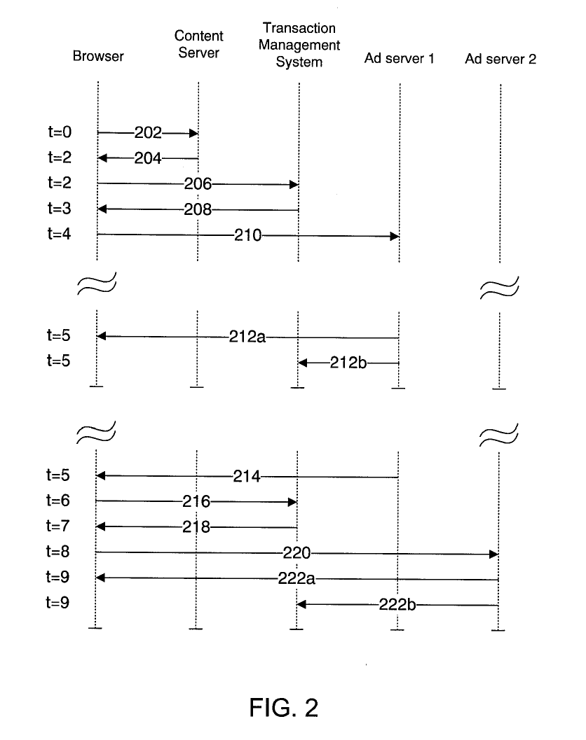

Aspects of the publisher tool will now be described with reference to FIGS. 1 and 2.

FIG. 1 shows an online advertisement brokering communication system 100 that includes content servers 102, advertisement servers 104, 106, 108 and various other computing systems interconnected via a network. Although the network is depicted as the Internet 110, the network may include any configuration of public/private networks.

One of the computing systems is a transaction management system 112 that provides a common data communication platform, which brings together publishers, advertisers, and advertisement networks (referred to collectively as “business entities”) in an open advertisement exchange environment. The transaction management system 112 may be implemented as a multi-server system having a server computer 114 that runs a manager application 116 to facilitate commercial transactions between the business entities, a server computer 118 that runs an accounting application 120 to track and manage accounting activity associated with the commercial transactions, and a server computer 122 that runs a prediction engine 124 to generate one or more predictive metrics for use by the manager application in facilitating a commercial transaction. Other server computers and/or applications may also be included in the transaction management system 112. Further, although depicted as separate server computers, in some implementations, one or more of the applications runs on a single server computer.

To participate on the exchange, each business entity registers with the transaction management system 112. Details of the types of information that a business entity may be requested or required to provide to the transaction management system 112 during the registration process can be found in U.S. patent application Ser. No. 11/669,690, entitled “Open Media Exchange Platforms,” filed on Jan. 31, 2007, the contents of which are hereby incorporated by reference in its entirety.

At times in this description, it may be necessary to distinguish advertisers and advertisement networks that are registered to participate on the exchange from those that are not. Accordingly, in this description, the term “exchange ad network” refers to an advertiser or an advertisement network that is registered to participate on the exchange, the term “3^{rd} party ad network” refers to an advertiser or an advertisement network with campaigns that are trafficked into the exchange by way of a publisher as discussed below; the term “ad creative supplier” refers to an exchange or 3^{rd} party advertiser or advertisement network. Examples of exchange ad networks on the Right Media Exchange include networks of the following: Accelerator (a division of Media Initiatives Group Ltd.), Active Response Group, Inc., Adtegrity.com, Inc., Bannerconnect (a division of Techconnect B.V.), CPX Interactive™, Directa Network (a company of Digital Ventures), Oridian Inc., Right Media Inc., and Rydium Canada Inc. Examples of 3^{rd} party ad networks that do not participate directly on the Right Media Exchange include ValueClick, Inc., Tribal Fusion®, and Advertising.com™.

3^{rd} party ad networks typically maintain their ad creative inventory on respective ad servers 108. An exchange ad network may choose to upload its ad creative inventory or some subset thereof to an exchange ad server 106 that stores ad creatives of multiple exchange ad networks. The uploaded ad creative inventory may be segmented within the exchange ad server 106 by the exchange ad network. In the alternative, an exchange ad network may choose to store its ad creative inventory on its own ad server 104 in a manner similar to that of a 3^{rd} party ad network.

Each ad creative that is stored on an ad server 104, 106, 108 is associated with a unique string of alphanumeric characters (referred to as a “creative identifier” or “creative ID”) that enables the ad creative to be selectably retrieved from the ad server on which it is located. Ad creatives of a common type and size may be grouped within an ad server by ad unit category. In such cases, an ad creative may be further associated with a string of alphanumeric characters (referred to as an “ad unit identifier”) that identifies an ad unit category to which the ad creative belongs. The table included below shows identifiers associated with an exemplary set of ad unit categories defined by type and size characteristics:

| Ad unit identifier | Type | Size (in pixels) |
|---|---|---|
| 1 | Large rectangle | 336 × 280 |
| 2 | Medium rectangle | 300 × 250 |
| 3 | Small rectangle | 180 × 150 |
| 4 | Vertical rectangle | 240 × 400 |
| 5 | Rectangle | 180 × 150 |
| 6 | 3:1 rectangle | 300 × 100 |
| 7 | Square pop-up | 250 × 250 |
| 8 | Pop-under | 720 × 300 |
| 9 | Full banner | 468 × 60 |
| 10 | Half banner | 234 × 60 |
| 11 | Micro bar | 88 × 31 |
| 12 | Button 1 | 120 × 90 |
| 13 | Button 2 | 120 × 60 |
| 14 | Vertical banner | 120 × 240 |
| 15 | Square button | 125 × 125 |
| 16 | Leaderboard | 728 × 90 |
| 17 | Wide skyscraper | 160 × 600 |
| 18 | Skyscraper | 120 × 600 |
| 19 | Half page ad | 300 × 600 |

Referring back to FIG. 1, one of the computing systems may be a publisher computing system 126 that includes a publisher tool 128. The publisher tool provides a user interface through which a publisher establishes links with exchange ad networks. Details regarding the techniques that may be implemented by the publisher tool 128 to enable link establishment can be found in U.S. patent application Ser. No. 11/669,764, entitled “Entity Linking in Open Exchange Platforms,” filed on Jan. 21, 2007, the contents of which are hereby incorporated by reference in its entirety. The link that is established between the publisher and an exchange ad network serves as a conduit through which the terms of a business relationship may be defined or continually redefined through the addition, deletion, or modification of relationship parameters, such as revenue share (e.g., 50-50 split between publisher and exchange ad network), payment options (e.g., check, wire transfer, and PayPal®), minimum payout (e.g., $20, $50, and $100), and payment terms (e.g., net 20 days).

A publisher may have business relationships with one or more 3^{rd} party ad networks. The terms of the business relationship that is established between the publisher and a given 3^{rd} party ad network may be defined by one or more line items. Each line item may include attribute information, price information, and constraint information. Generally, the attribute information relates to the qualitative and/or quantitative characteristics of an ad placement, such as type (e.g., banner, skyscraper, leaderboard, pop-up, and pop-under) and size (e.g., 468×60, 728×90, 120×600, 160×600, and 200×250). The price information generally represents a utility function for the placement, and may be expressed in terms of cost-per-action (CPA), cost-per-impression (CPI), cost-per-click (CPC), and cost-per-mille (CPM). The price information may also specify the terms of frequency caps, pre-negotiated discounts to be applied and reporting requirements. The constraint information generally relates to information that includes or excludes eligibility for a transaction. For instance, these constraints may include geographic targeting preferences (e.g., USA, UK, Canada, Europe, Asia, South America, Africa/Middle East and Australia/New Zealand) and site content nature requirements (e.g., no adult entertainment sites, adult entertainment sites, only sports-focused sites, and/or only English language sites).

In some implementations, the publisher tool 128 provides a user interface through which the publisher enters placement(s) for each of these 3^{rd} party ad networks so as to “traffic into the exchange” the applicable campaign(s) of those 3^{rd} party ad networks. Each placement generally corresponds to a line item of the business relationship between the publisher and the 3^{rd} party ad network, and represents an opportunity for the 3^{rd} party ad network to participate in a transaction on the exchange without itself being a participant on the exchange.

In one example, the publisher's account includes placements for 3^{rd} party ad networks Value Click and Tribal Fusion. The Value Click placement is defined by a 728×90 leaderboard-type ad unit that is priced at $2.00 CPM; the Tribal Fusion placement is defined by a 728×90 leaderboard-type ad unit priced at $1.50 CPM. Each placement is associated with an ad tag (e.g., a snippet of hypertext markup language (HTML) code) that includes an ad unit identifier and an ad server (or server segment) identifier representative of the 3^{rd} party ad server 108 from which ad creatives of an ad unit category corresponding to the ad unit identifier may be retrieved. Other/different information may be included in an ad tag, e.g., in lieu of an ad unit identifier, an ad unit size and type may be explicitly recited.

The information (including ad tags) associated with the business entities may be stored in a data store (e.g., a database 130) coupled to the transaction management system 112 or accessible by the transaction management system 112 via a network (e.g., the Internet 110, a local area network, or a wide area network).

FIG. 2 shows a timing diagram chart of an exemplary ad creative serving process.

Referring to FIGS. 1 and 2, in operation, when a user at a web browser 132 of a client computing system 130 visits a publisher's website, the browser sends (202) a request to the publisher's content server 102 to request a web page. The content server 102 returns (204) the requested web page, which may include one or more ad tags.

The browser 132 makes a tag-specific ad call for each ad tag included in the requested web page. Suppose, for example, that the browser 132 makes (206) a tag-specific ad call to the exchange for a 728×90 leaderboard-type ad creative. The receipt of the ad call by the exchange triggers the transaction management system 112 to determine whether the received ad call is a first instance of an ad call for the requested creative. A “first instance of an ad call” as used in this description refers to an ad call for which no previous attempt to serve an ad creative responsive to the ad call was initiated by the exchange. If the user navigates away from the web page and returns to it, or reloads it, the subsequent ad call that is made by the browser to the exchange is considered a second, different ad call, not a second instance of the original ad call.

If it is determined that the received ad call is a first instance of an ad call, the transaction management system 112 identifies a set of advertisement networks (“eligible set”) eligible to participate in a transaction with the publisher involving the requested ad creative, and performs a series of decision processes (collectively referred to in this description as an “auction”) to identify the advertisement network of the eligible set that provides the publisher with the best price for filling the ad space (in this case, a 728×90 leaderboard-type ad space) under the pricing rules that are employed by the exchange. Although in most instances, the “best price” for the ad space is the price which yields the highest revenue for the publisher, there are instances in which the “best price” is based on other metrics (e.g., ad frequency). Details regarding the techniques that may be implemented by the exchange in identifying the eligible set of advertisement networks, and performing the series of decision processes can be found in U.S. patent application Ser. No. 11/669,690, entitled “Open Media Exchange Platforms,” filed on Jan. 31, 2007, the contents of which are hereby incorporated by reference in its entirety. The advertisement network that is associated with the “best price” is the “winning ad network” for the auction.

The transaction management system 112 returns (208) to the user's web browser an ad tag for the winning ad network's 728×90 leaderboard-type ad unit. The user's web browser executes the ad tag and makes (210) a tag-specific ad call to an ad server.

As a condition of participating on the exchange, each winning exchange ad network may be required to serve an ad creative at the stated “best price” without an option to default on the impression by returning to the user's web browser an ad creative that satisfies characteristics of the ad unit. Accordingly, in those instances in which the ad call of step 210 is made to an ad server of an exchange ad network, the ad server returns (212a) a suitable 728×90 leaderboard-type ad creative to the browser 134 and sends (212b) a notification to the transaction management system 112 that the impression has been filled. Upon receipt of the notification, the transaction management system 112 counts the impression towards the exchange ad network and the process terminates.

As 3^{rd} party ad networks are not participants on the exchange, there is no guarantee that a winning 3^{rd} party ad network's ad server will serve an ad creative at the stated “best price” upon receipt of an ad call from the user's web browser. The winning 3^{rd} party ad network may choose to default on the impression (e.g., due to lack of appropriate inventory).

To avoid those scenarios in which a winning 3^{rd} party ad network serves a public service announcement in lieu of an ad creative, or otherwise defaults on an unwanted impression, the publisher provides passback tags to each of its 3^{rd} party ad networks for placement on the networks' respective ad servers. Each passback tag functions to direct an unwanted impression back to the exchange for re-auction. In one implementation, a passback tag includes a 3^{rd} party ad network identifier and an ad unit identifier.

Returning to FIG. 2, in those instances in which the ad call of step 210 is made to an ad server of a 3^{rd} party ad network, and that 3^{rd} party ad network chooses to serve the impression, the ad server of the 3^{rd} party ad network returns (212a) a suitable ad creative to the browser 134 and sends (212b) a notification to the transaction management system 112 that the impression has been filled. In those instances in which the 3^{rd} party ad network (e.g., Value Click) chooses to default on the impression, its ad server selects an ad-unit-appropriate passback tag to be returned (214) to the user's web browser 134. For example, if the ad call of step 210 was for a 728×90 leaderboard-type ad creative, the ad server returns (214) a passback tag that includes an ad unit identifier of “16.”

The receipt of the passback tag at the user's web browser 134 signals the beginning of a passback session. The user's web browser 134 stores the passback tag locally on the client computing system 132 in a session-specific JavaScript array, and makes (216) an ad call to the exchange. In one example, the browser 134 passes the session-specific JavaScript array to the transaction management system 112 as part of the ad call.

The receipt of the ad call by the exchange triggers the transaction management system 112 to determine whether the received ad call is a first instance of an ad call for the requested creative. In one implementation, the presence of a session-specific JavaScript array signifies to the transaction management system 112 that one or more previous attempts have been made to serve an ad creative responsive to the ad call. The transaction management system 112 loads the session-specific JavaScript array, which contains the passback tag that was returned in step 212b, into a vector and uses the vector to identify the one or more ad networks associated with the previous attempts to serve the ad creative. These ad networks are designated by the transaction management system 112 as ineligible to participate in the current transaction with the publisher involving the 728×90 banner-type ad space and are removed from the eligible set.

The transaction management system 112 then performs a second auction to identify the winning ad network of the eligible set, and returns (218) to the user's web browser 134 an ad tag for the winning ad network's 728×90 banner-type ad unit. The user's web browser 134 executes the ad tag and makes (220) an ad call to an ad server identified within the ad tag. If the ad server chooses to fill the impression, an ad creative is returned to the user's web browser 134 in step 222a and a notification is sent (222b) to the transaction management system 112 indicating that the impression has been filled. Else, the ad server returns (222a) its own passback tag and the process repeats.

Each time a passback tag is returned to the user's web browser 134, it is added to the existing session-specific JavaScript array. All ad networks having identifiers within a session-specific JavaScript array are eliminated from any and all auctions that take place during the current passback session. The browser 134 may be prompted to clear its session-specific JavaScript array upon being served an ad creative. In some implementations, the browser 134 may further be prompted to forward the ad server identifier associated with the creative that is served to the exchange in a confirmation message for reporting purposes.

The accounting application 120 of the transaction management system 112 may be implemented to maintain two separate tables for reporting purposes. The first table is used to track the number of instances in which a 3^{rd} party ad network defaults on an impression. This value may be tracked by counting each instance in which a particular ad server identifier appears in a passback tag that is included in a session-specific JavaScript array received by the exchange. The second table is used to track the impression count per ad network. Referring to FIG. 2, in those instances in which an ad tag that is returned to the user's web browser in step 208 is associated with an exchange ad network, the accounting application may be implemented to automatically count an impression towards the exchange ad network or wait until a notification that the impression has been filled is received by the transaction management system 112. In those instances in which the ad tag of step 208 is associated with a 3^{rd} party ad network, the accounting application only counts the impression towards the 3^{rd} party ad network when a confirmation message from of the ad creative serving is received (either from the ad network or from the browser.

In the example described above, the publisher provides passback tags to each of its 3^{rd} party ad networks for placement on the networks' respective ad servers. In some cases, 3^{rd} party ad networks do not permit the placement of passback tags on their ad server. Rather, the 3^{rd} party ad networks only permit publishers' to enter URLs as their respective defaults. In such cases, a section targeting technique may be implemented to enable defaulted impressions to be returned to the exchange for re-auctioning.

Suppose, for example, that a publisher has a site, www.site1.com, and business relationships with two 3^{rd} party ad networks, Value Click and Tribal Fusion. The publisher generates a section for each ad network and assigns a passback tag to each section. For example, the section for the Value Click (VC) ad network has a URL of www.site1.com/ValueClickPassback, and is associated with a passback tag (“VC passback tag”) that includes a VC section identifier; the section for the Tribal Fusion (TF) ad network has a URL of www.site1.com/TribalFusionPassback, and is associated with a passback tag (“TF passback tag”) that includes a TF section identifier. The publisher provides the passback URL of “www.site1.com/ValueClickPassback” to the Value Click ad network for placement on its ad server for use during a default, and does likewise for the Tribal Fusion ad network.

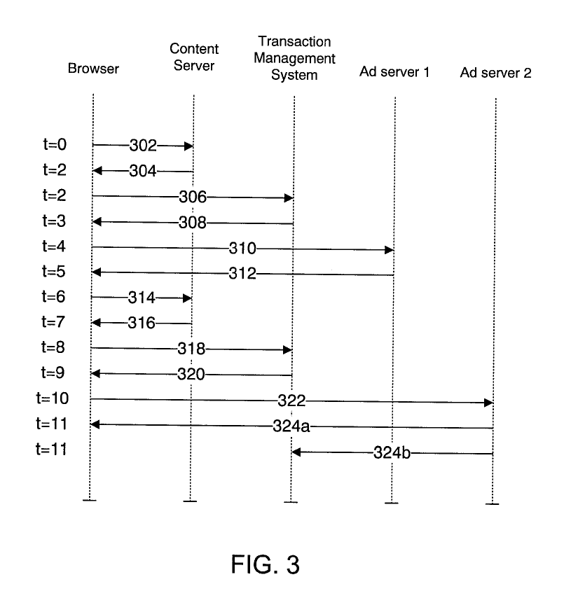

Referring now to FIGS. 1 and 3, in operation, when a user at a web browser 132 of a client computing system 130 visits a publisher's website, the browser sends (302) a request to the publisher's content server 102 to request a web page. The content server 102 returns (304) the requested web page, which may include one or more ad tags. Suppose, for example, that the browser 132 makes (306) a tag-specific ad call to the exchange for a 728×90 leaderboard-type ad creative. The transaction management system 112 determines that the received ad call is a first instance of an ad call for the requested creative, and performs an auction to identify an advertisement network of an eligible set that provides the publisher with the best price for filling the ad space (in this case, a 728×90 leaderboard-type ad space) under the pricing rules that are employed by the exchange. The transaction management system 112 returns (308) to the user's web browser an ad tag for the winning ad network's 728×90 leaderboard-type ad unit. In one example, the winning ad network is the Value Click ad network. The user's web browser executes the ad tag and makes (310) a tag-specific ad call to an ad server of the Value Click ad network.

If the Value Click ad network chooses to default on the impression, its ad server returns (312) its passback URL of “www.site1.com/ValueClickPassback” to the user's web browser 134. The browser 134 sends (314) a request to the publisher's content server 102 to request a web page corresponding to the “www.site1.com/ValueClickPassback” passback URL. The content server 102 returns (316) the VC passback tag associated with the VC passback URL to the browser 134, which executes the VC passback tag to make (318) an ad call to the exchange. In one example, the browser 134 passes the VC section identifier to the transaction management system 112 as part of the ad call.

The receipt of the ad call by the exchange triggers the transaction management system 112 to determine whether the received ad call is a first instance of an ad call for the requested creative. In one implementation, the presence of the VC section identifier signifies to the transaction management system 112 that one or more previous attempts have been made to serve an ad creative responsive to the ad call. The transaction management system 112 designates the Value Click ad network as ineligible to participate in an auction involving ad calls from www.site1.com/ValueClickPassback. In so doing, the transaction management system 112 eliminates all placements associated with the Value Click ad network from competing for impressions from www.site1.com/ValueClickPassback following the default.

The transaction management system 112 then performs a second auction to identify the winning ad network of the eligible set, and returns (320) to the user's web browser 134 an ad tag for the winning ad network's 728×90 banner-type ad unit. The user's web browser 134 executes the ad tag and makes (322) an ad call to an ad server identified within the ad tag. If the ad server chooses to fill the impression, an ad creative is returned to the user's web browser 134 in step 324a and a notification is sent (324b) to the transaction management system 112 indicating that the impression has been filled. Else, the ad server returns (324a) its own passback URL and the process repeats.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Other embodiments are within the scope of the following claims. The following are examples for illustration only and not to limit the alternatives in any way. The techniques described herein can be performed in a different order and still achieve desirable results. For example, the techniques may be implemented such that the information representative of an ad creative supplier that defaulted on serving an ad creative responsive to a previous instance of the ad call is provided in a cookie rather than a JavaScript array.

1. A computer-implemented method comprising:
at an exchange computing system,
receiving an ad call from a client computing system; and
determining whether an instance of the ad call was previously-received, and if so, designating a first ad creative supplier associated with the previous instance of the ad call as ineligible to participate in an auction in which a second ad creative supplier is selected to serve an ad creative responsive to the ad call.

2. (canceled)

3. The method of claim 1, further comprising:
at the exchange computing system, performing the auction, and sending an ad tag associated with the second ad creative supplier to the client computing system.

4. The method of claim 1, further comprising:
at the exchange computing system, performing the auction by comparing bids associated with a set of ad creative suppliers, and identifying the second ad creative supplier from amongst the set of ad creative suppliers as being associated with a winning bid for the auction.

5. The method of claim 4, wherein the winning bid corresponds to a bid price that yields a highest revenue for a publisher.

6. The method of claim 1, wherein determining whether an instance of the ad call was previously-received comprises:
determining whether the ad call includes information representative of an ad creative supplier that defaulted on serving an ad creative responsive to the previous instance of the ad call.

7. The method of claim 1, further comprising:
at the exchange computing system, counting a defaulted impression towards the first ad creative supplier upon the designating.

8. A computer-implemented method comprising:
determining whether an ad call received from a client computing system results from an execution of a set of instructions included in a passback tag, and if so, designating each ad creative supplier having an identifier present in the received ad call as ineligible to participate in an auction in which an ad creative supplier is selected to serve an ad creative responsive to the ad call.

9. The method of claim 8, wherein determining whether an ad call received from the client computing system results from an execution of a set of instructions included in a passback tag comprises:
examining the ad call to determine whether the ad call includes information representative of an ad creative supplier that defaulted on serving an ad creative responsive to a previous instance of the ad call.

10. The method of claim 8, further comprising:
sending an ad tag associated with the selected ad creative supplier to the client computing system.

11. The method of claim 8, further comprising:
performing the auction by comparing bids associated with a set of ad creative suppliers, and identifying, from amongst the set, the ad creative supplier having a bid price that yields a highest revenue for a publisher.

12. A online advertisement brokering communication system comprising:
an exchange computing system having a processor and a memory that stores instructions to cause the processor to:
determine whether an ad call received from the client computing system results from an execution of a set of instructions included in a passback tag, and if so, designate each ad creative supplier having an identifier present in the received ad call as ineligible to participate in an auction in which an ad creative supplier is selected to serve an ad creative responsive to the ad call.

13. The system of claim 12, wherein the instructions to cause the processor to determine whether an ad call received from the client computing system results from an execution of a set of instructions included in a passback tag comprise instructions to:
examine the ad call to determine whether the ad call includes information representative of an ad creative supplier that defaulted on serving an ad creative responsive to a previous instance of the ad call.

14. The system of claim 12, wherein the memory of the exchange computing system further stores instructions to cause the processor to:
send an ad tag associated with the selected ad creative supplier to the client computing system.

15. The system of claim 12, wherein the memory of the exchange computing system further stores instructions to cause the processor to:
perform the auction by comparing bids associated with a set of ad creative suppliers, and identifying, from amongst the set, the ad creative supplier having a bid price that yields a highest revenue for a publisher.

16. The system of claim 12, further comprising:
an ad server having a processor and a memory that stores instructions to cause the processor to:
selectably default on serving an ad creative responsive to an ad call received from a client computing system; and
send a passback tag to the client computing system, the passback tag including a set of instructions operable to cause the client computing system to make an ad call to the exchange computing system.

17. The system of claim 16, wherein the memory of the ad server further stores one or more passback tags, each passback tag including an ad unit identifier and an ad network identifier: and wherein the instructions stored in the memory of the ad server comprise instructions to cause the processor to:
examine the ad call received from the client computing system to identify a requested ad unit: and
select the passback tag to be sent to the client computing system based on the requested ad unit, wherein the selected passback tag includes an ad unit identifier corresponding to the requested ad unit.

18. (canceled)

19. The system of claim 12, further comprising:
an ad server having a processor and a memory that stores instructions to cause the processor to:
selectably default on serving an ad creative responsive to an ad call received from a client computing system; and
send a passback URL to the client computing system.

20. A machine-readable medium that stores executable instructions to cause a machine to:
receive an ad call from a client computing system; and
determine whether an instance of the ad call was previously-received, and if so, designate a first ad creative supplier associated with the previous instance of the ad call as ineligible to participate in an auction in which a second ad creative supplier is selected to serve an ad creative responsive to the ad call.

21. The machine-readable medium of claim 20, further comprising instructions to cause the machine to:
perform the auction, and send an ad tag associated with the second ad creative supplier to the client computing system.

22. The machine-readable medium of claim 20, further comprising instructions to cause the machine to:
perform the auction by comparing bids associated with a set of ad creative suppliers, and identifying the second ad creative supplier from amongst the set of ad creative suppliers as being associated with a winning bid for the auction.

23. The machine-readable medium of claim 20, wherein instructions to cause the machine to determine whether an instance of the ad call was previously-received comprise instructions to:
determine whether the ad call includes information representative of an ad creative supplier that defaulted on serving an ad creative responsive to the previous instance of the ad call.

24. The machine-readable medium of claim 20, further comprising instructions to cause the machine to:
count a defaulted impression towards the first ad creative supplier upon the designation.

25. A machine-readable medium that stores executable instructions to cause a machine to:
determine whether an ad call received from the client computing system results from an execution of a set of instructions included in a passback tag, and if so, designate each ad creative supplier having an identifier present in the received ad call as ineligible to participate in an auction in which an ad creative supplier is selected to serve an ad creative responsive to the ad call.

26. The machine-readable medium of claim 25, wherein the instructions to cause the machine to determine whether an ad call received from the client computing system results from an execution of a set of instructions included in a passback tag comprise instructions to:
examine the ad call to determine whether the ad call includes information representative of an ad creative supplier that defaulted on serving an ad creative responsive to a previous instance of the ad call.

27. The machine-readable medium of claim 25, further comprising instructions to cause the machine to:
send an ad tag associated with the selected ad creative supplier to the client computing system.

28. (canceled)
